(19) United States
(12) Patent Application Publication
(10) Pub. No.: US 2009/0097358 A1
(43) Pub. Date: Apr. 16, 2009

(54) Seismic Monitoring Of Heavy Oil

(76) Inventors: James Martin, Cabridgeshire (GB); Bjorn Rommel, Cambridgeshire (GB); Trevor Hughes, Cambridge (GB); Gwenola Michaud, Tokyo (JP)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(21) Appl. No.: 11/792,448

(22) PCT Filed: Dec. 2, 2005
(86) PCT No.: PCT/GB05/04620

§ 371 Date: Mar. 17, 2008

(30) Foreign Application Priority Data
Dec. 7, 2004 (GB) 0426789.4

(51) Int. Cl. G01V 1/30

(52) U.S. Cl. 367/75

(57) ABSTRACT

A method of monitoring heavy oil recovery in a hydrocarbon reservoir including the steps of obtaining a set of acoustic signals; deriving from the obtained signals a velocity model including shear and compressional velocities for at least a section of the reservoir; defining a relation relating shear and compressional velocities to at least one material parameter of the heavy oil; performing a reservoir treatment process; obtaining an in-situ or post-treatment set of acoustic signals; and deriving from the in-situ or post-treatment set of acoustic signals shear and compressional velocities and the at least one material parameter using the relation.

The invention relates to a method of monitoring heavy oil recovery in a hydrocarbon reservoir using acoustic, particularly seismic signals.

### BACKGROUND OF THE INVENTION

Heavy oil including bitumen and tars are hydrocarbons with a high density. Density is usually defined in terms of degrees American Petroleum Institute (API) gravity, which is related to specific gravity—the denser the oil, the lower the API gravity. Hydrocarbon API gravities range from 40 for tar-rich bitumen to 700 for condensates. Heavy oil occupies a range along this continuum between ultra-heavy oil and light oil. The US Department of Energy (DOE) defines heavy oil as between API gravities 10.00 and 22.30. However, nature recognizes no such boundaries. In some reservoirs, oil with gravity as low as 70 or 80 is considered heavy rather than ultra-heavy because it can be produced by heavy-oil production methods. For the purpose of this invention, reservoirs with oils of API gravities between about 70 and 200 are considered to be heavy-oil reservoirs if they are produced by enhanced oil-recovery (EOR) techniques that are atypical for medium or light oils which usually flows under reservoir pressure into the well bore. Heavy oil is thus defined by having API gravities between about 70 and 200 and requiring EOR to be produced through well bore tubing. The most viscous tar, pitch and bitumen deposits at even lower API gravities usually require mining-style methods for economic exploitation and are not considered here.

Heavy oil reservoirs are thus characterized by a number of techniques used either in practice or which are proposed to mobilize the heavy oils so that they flow and can be produced from hydrocarbon reservoirs. Steam injection, chemical alteration or microbiological mobilization can all be used to mobilize oil. Steam injection heats up the oil within the reservoir, lowering the heavy oil's viscosity enabling it to move more freely. Steam injection consumes large amounts of energy and is less efficient that chemical or biological stimulation. Chemical and biological agents can be used to alter the oil in-situ, forming lower viscosity fraction, gas and other by-products—but enabling the lower viscosity fractions to be produced. Chemical and especially biological intervention will probably take a number of years to successfully mobilize heavy oil such that it can be produced.

Each of the mobilization techniques require that the state of the hydrocarbons in the reservoir be monitored so that: (a) the dispersion of reagents within the reservoir can be monitored, (b) the maturation of the alteration process can be monitored so that decisions can be made as to when and how to start production, (c) zones within the reservoir that have not been mobilized by the reagents can be identified and remedial action taken.

A general overview of acoustic methods used for monitoring reservoirs is given for example in the international published patent application WO 03/036031, incorporated herein by reference. In the field of heavy oil several studies have been published that use seismic reservoir monitoring to monitor heavy oil recovery. Known studies such as S. Sun in CSEG Recorder October 2001, 29-36 or M. Mathisen et al. Geophysics 60, No. 3, May-June 1995, p 651-659 describes the monitoring of steam-enhanced recovery, also incorporated herein by reference.

### SUMMARY OF THE INVENTION

The present invention relates fluid parameters, such as viscosity, density, bulk and shear moduli, Poisson's ratio of the heavy oil, within the reservoir with the compressional and shear wave velocities of sound propagation within the reservoir.

The alteration of heavy oil viscosity to producible states can be monitored by time-lapse monitoring of the change of the compressional and shear wave velocities of sound propagation within the hydrocarbon reservoir. The relationship between viscosity and heavy oil alteration process monitoring can be exploited to make decisions on reservoir production.

The methods described herein are suitable to detect zones of different temperatures and/or the presence of gas as other known methods, but more importantly they distinguish between different states of the heavy oil. Thus, decisions relating to the production of a heavy oil reservoir can be based on the observed state of the heavy oil. The progress of EOR operations that alter the material parameters of the heavy oil such as microbiological activity that is designed to reduce for example viscosity can be directly monitored and controlled.

These and other features of the invention, preferred embodiments and variants thereof, possible applications and advantages will become appreciated and understood by those skilled in the art from the following detailed description, appended drawings and claims.

### BRIEF DESCRIPTION OF DRAWINGS

FIG. 1 illustrates a sequence of steps in accordance with an example of the invention; and

FIG. 2 illustrates the distribution of sources and receivers for a sparsely sampled seismic survey.

### DETAILED DESCRIPTION OF THE INVENTION

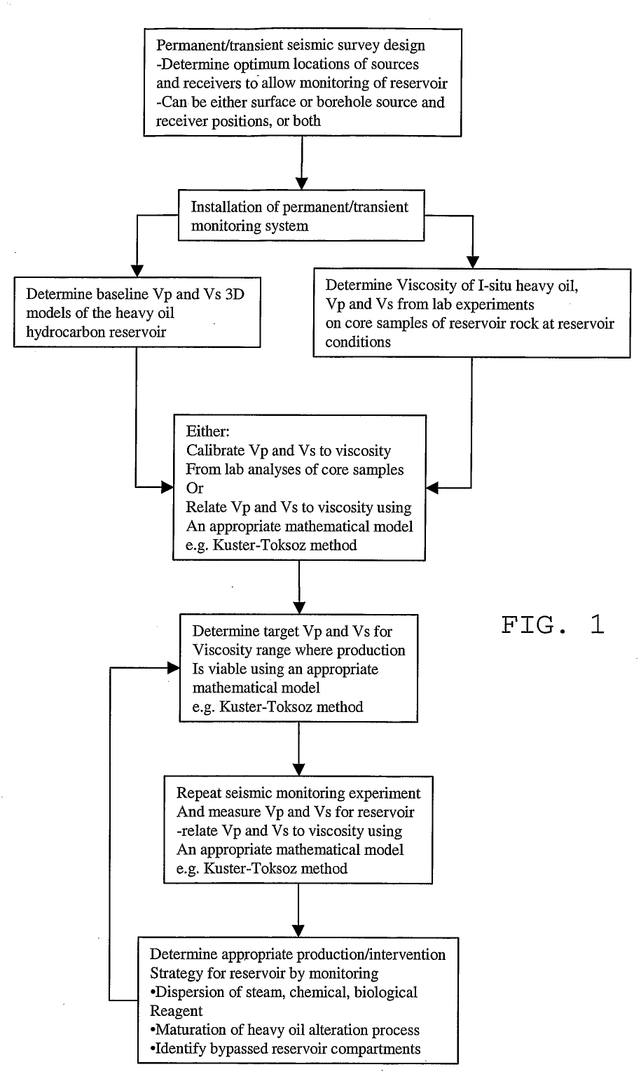

The steps as shown in FIG. 1 are described in the following:

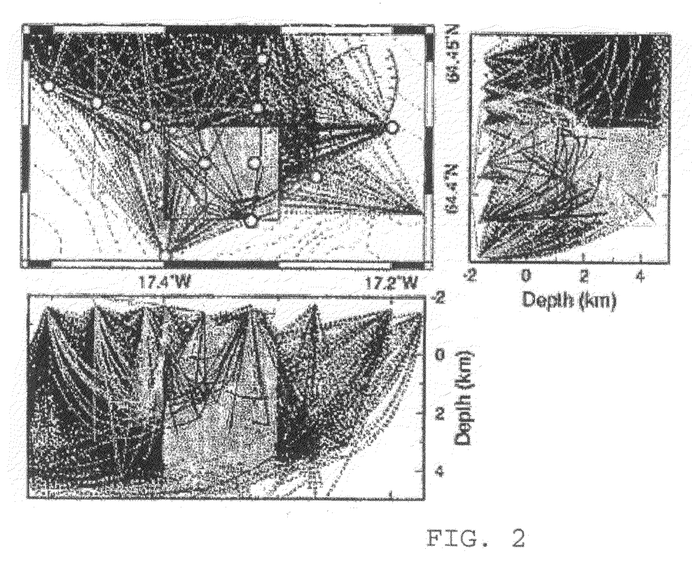

A sparse network of seismic source and receiver positions is defined at the heavy oil reservoir, such that the seismic rays propagating between each source and all of the seismic receivers pass through a part of the reservoir and key structural features of interest that might form blocks of hydraulic connectivity between each reservoir compartment (see FIG. 2.). A baseline seismic survey is used to measure the travel time between each source and receiver. Tomographic inversion as described for example in Mathisen et al above for the purpose of detecting gas can be used to estimate the compressional and shear wave velocities Vp Vs along each ray passing through the reservoir.

The rays are shown as clustered lines in FIG. 2. Further information about the compressional and shear wave velocities can also be obtained from either sonic and di-pole sonic logs, VSP's or existing surface seismic data and used to constrain the velocity model.

The seismic source and receiver positions indicated as circles in FIG. 2 can be located either on the surface or within boreholes, or may be a combination of surface and borehole locations.

Core samples of the reservoir rock can be confined to mimic reservoir temperature and pressure conditions, and thus the compressional and shear wave velocities can alternatively be estimated from laboratory experiments.

Once a baseline measurement is performed, the in-situ compressional and shear wave velocity alteration is estimated using time-lapse seismic surveying, and can be related to the alteration of the properties or parameters of the hydrocarbon through which the rays between each of the seismic source-receiver pairs passes, enabling the monitoring of the state of the hydrocarbon reservoir.

The mathematical relationship relating for example hydrocarbon viscosity to compressional and shear wave velocity is used to estimate target compressional and shear wave velocities, which, once achieved, infer that the hydrocarbons have a sufficiently low viscosity to enable production.

The Kuster-Toksoz theory as described in: G. T. Kuster and M. N. Tuksoz Geophysics 39 (1974) 583-606 is a suitable theory relating compressional and shear wave velocity of a heavy oil saturated reservoir rock to hydrocarbon parameters, such as bulk moduli, shear moduli, Poisson's ratio density and viscosity. Alternative formulations for an effective medium, such as based on the Gassmann model or variation principle (see for example: Z. Hashin and S. Shrikman J. Mech Phys. Solids, 11, 1963, 127-140) may be used, particularly to more accurately define this relationship as the hydrocarbon becomes less viscous. However the model used should be capable of accounting for a substantial shear wave velocity in the fluid, i.e., the heavy oil component. The model is then used to determine the elastic moduli and densities of the rock solid and the pore fluids including the heavy oil. For a more accurate description of the pressure, frequency and temperature dependency use can be made of approximations described for example in M. Batzle and Z. Wang, Geophysics 57, 1992, 1396-1408 and the references therein.

Large changes in viscosity may also be induced and hence observed when the asphaltenes (the heavy components) in the heavy oil precipitate thus yielding a lower viscosity liquid phase and a solid precipitate. This may occur in pipes (bulk), near-wellbore location due to changes in pressure, with chemical or biological treatments where viscosity-reducing components perturb phase behavior.

It is also possible to derive the viscosity from complex moduli, in which the imaginary part can be related to the attenuation or viscosity of the fluid.

Having derived material parameters of the heavy oil and their changes in course of an enhanced recovery treatment or production through time-lapse measurement, further production, intervention and optimization decisions can be made to optimize production.

The 3D compressional and shear wave velocity depth models produced from the velocity or tomographic inversion of the seismic data of the heavy oil hydrocarbon reservoir can be converted to 3D viscosity-depth models of the reservoir. Such mappings of the velocity and viscosity characteristics will prove to be useful interpretation aids to monitor changes in velocity or viscosity from time-lapse seismic surveys, so that alteration of heavy oil be monitored, allowing: (a) the dispersion of reagents within the reservoir to be monitored, (b) to monitor the maturation of the alteration process so that decisions can be made as to when and how to start production, (c) to identify zones within the reservoir that have not been mobilized by the reagents and to take remedial action.

In addition, the time-lapse changes in the repeated seismic waveform itself may be monitored and/or the attenuation changes (frequency content of the seismic wavelet). This could provide an additional constraint for the determination of viscosity from seismic data. The link of viscosity to Q (high frequency) attenuation is also very sensitive and will change with the alteration of the state of viscosity during heavy oil alteration into less viscous components.

As alternatives to the active time-lapse seismic surveying procedure outlined above, monitoring of heavy oil reservoir alteration may be achieved using any of the following methods:
Passive seismic monitoring: A distribution of seismic sensors either on the surface, in one or more wells or a combination of both placements, would monitor the natural acoustic emissions emitted from the reservoir as the heavy oil alteration progresses. Location of the micro-seismic events that occur either within or below the reservoir will allow a tomographic 3D velocity model of the reservoir to be determined and updated as heavy oil alteration progresses. Updated 3D reservoir tomographic models for Vp and Vs determined from such micro-seismic events can be similarly related to viscosity as in the active reservoir monitoring embodiment.
High frequency sonic and di-pole sonic logs from wells distributed throughout the reservoir can be used to measure changes in Vp and Vs, which in turn can be related to changes in viscosity, when used in time-lapse mode.
Cross-well seismic data, which is a subset of the active time-lapse survey can also be used to monitor changes in Vp and Vs and hence changes in viscosity. The changes in seismic wavelet attenuation can also be monitored by this method and related to viscosity changes.

Various embodiments and applications of the invention have been described. The descriptions are intended to be illustrative of the present invention. It will be apparent to those skilled in the art that modifications may be made to the invention as described without departing from the scope of the claims set out below.

1. A method of monitoring heavy oil recovery in a hydrocarbon reservoir comprising the steps of
obtaining a set of acoustic signals;
determining from the obtained signals a velocity model including shear and compressional velocities for at least a section of the reservoir;
defining a relation relating shear and compressional velocities to at least one material parameter of the heavy oil;
performing a reservoir treatment process;
obtaining an in-situ or post-treatment set of acoustic signals; and
determining from the in-situ or post-treatment set of acoustic signals shear and compressional velocities and the at least one material parameter using the relation.

2. The method of claim 1 wherein the acoustic signals include seismic signals.

3. The method of claim 1 wherein the at least one material parameter is selected from a group consisting of viscosity, density, bulk modulus, shear modulus and Poisson's ratio.

4. The method of claim 1 wherein the relation relating shear and compressional velocities to at least one material parameter is determined through calibration.

5. The method of claim 1 wherein the relation relating shear and compressional velocities to at least one material parameter is determined through a model.

6. The method of claim 1 wherein the relation relating shear and compressional velocities to at least one material parameter is determined through a model assuming that the heavy oil is capable of transmitting shear waves.

7. The method of claim 1 wherein the acoustic signals are obtained through a sparse sampled seismic survey.

8. The method of claim 1 wherein the shear and compressional velocities are defined in a three-dimensional model.
